(19) United States
(12) Patent Application Publication
(10) Pub. No.: US 2008/0127218 A1
(43) Pub. Date: May 29, 2008

(54) Event dispatcher based on subscriber dependencies

(75) Inventors: Jason A. Huck, Fargo, ND (US); Matthew Thalman, Fargo, ND (US); Paul R. Bramel, Fargo, ND (US); Timothy J. Brookins, West Fargo, ND (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/477,280

(22) Filed: Jun. 28, 2006

(51) Int. Cl. G06F 9/54

(52) U.S. Cl. 719/318

(57) ABSTRACT

Various technologies and techniques are disclosed that dispatch events in a particular order. The event dispatcher receives an event trigger for an event from an event publisher. The event dispatcher uses a reverse topological sort on a module dependency tree to produce a sorted list of modules. The sorted list of modules has each module in order by dependency. The sorted list of modules is used invoke the subscriptions in order by dependency. The sorted list can be used along with additional information to invoke subscriptions in a particular order.

### BACKGROUND

Developers who write their code by subscribing to events expect their code to be executed in a predictable fashion. In some application environments, an event uses a multicast delegate which invokes the subscribers in the order in which they originally added themselves as subscribers. This approach is not functional enough in scenarios where subscribers have dependencies upon one another. When multiple product vendors build add-ons to a base product, they produce product dependencies. These add-ons all depend on the base product and they may depend on one or more other add-ons.

Subscriber A which is dependent on Subscriber B requires Subscriber B's logic to execute before its own. Since Subscriber A is aware of Subscriber B, it can correctly compensate for any logic executed by Subscriber B. However, it is much more difficult if Subscriber B has to compensate for Subscriber A's logic since it doesn't even know of Subscriber A's existence. This is why Subscriber B's logic should be executed before Subscriber A's. But it may not always be possible for Subscriber A to add its subscription to a particular event after Subscriber B. If Subscriber A were to add its event subscription first, many application environments cause Subscriber A to be executed first, which is not the desired behavior.

### SUMMARY

Various technologies and techniques are disclosed that dispatch events in a particular order. The event dispatcher receives an event trigger for an event from an event publisher. The event dispatcher uses a reverse topological sort on a module dependency tree to produce a sorted list of modules. The sorted list of modules has each module in order by dependency. The sorted list is used to invoke the subscriptions in order by dependency. The sorted list can be used along with additional information to invoke subscriptions in a particular order. In one implementation, the additional information is used to help resolve a tie. In another implementation, the additional information is used to help switch an order of one or more modules in a manner to improve performance.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an event dispatcher application of one implementation operating on the computer system of FIG. 1.

FIG. 3 is a process flow diagram for one implementation of the system of FIG. 1 illustrating the stages involved in providing an event dispatcher for managing invocation of subscriptions based on subscriber dependencies.

FIG. 4 is a process flow diagram for one implementation of the system of FIG. 1 illustrating the stages involved in generating a sorted list of subscriptions from an unsorted list of subscriptions and a sorted module list by looking at a list of subscriptions first and then the modules from which they come.

FIG. 5 is a process flow diagram for one implementation of the system of FIG. 1 illustrating the stages involved in generating a sorted list of subscriptions from an unsorted list of subscriptions and a sorted module list by looking at the modules first and then the subscriptions.

FIG. 6 is a process flow diagram for one implementation of the system of FIG. 1 that illustrates the stages involved in performing a reverse topological sort using dependency information plus additional information to determine the list.

FIG. 7 is a logical diagram for one implementation of the system of FIG. 1 that illustrates an interaction among hypothetical components.

FIG. 8 is a logical diagram for one implementation of the system of FIG. 1 that illustrates a sample module dependency tree.

FIG. 9 is a process flow diagram for one implementation of the system of FIG. 1 that illustrates the stages involved in invoking the subscriptions based on the example dependency tree of FIG. 8.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that dispatches events, but the system also serves other purposes in addition to these. In one implementation, one or more of the techniques described herein can be implemented as features within a program execution environment such as MICROSOFT®.NET Framework, or from any other type of program or service that manages the dispatching of events among components.

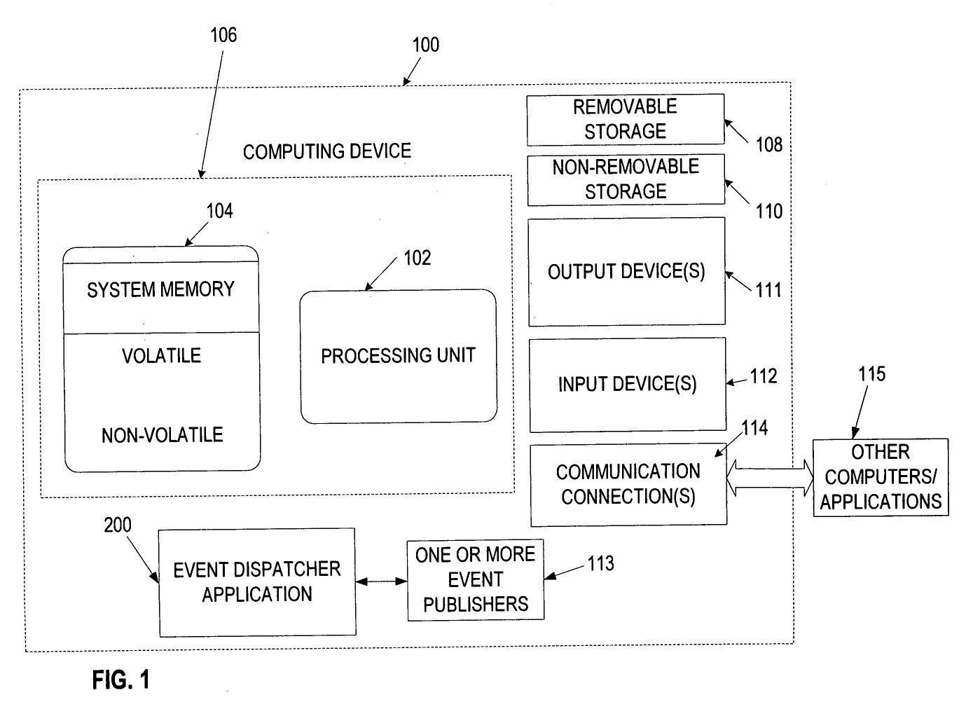

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

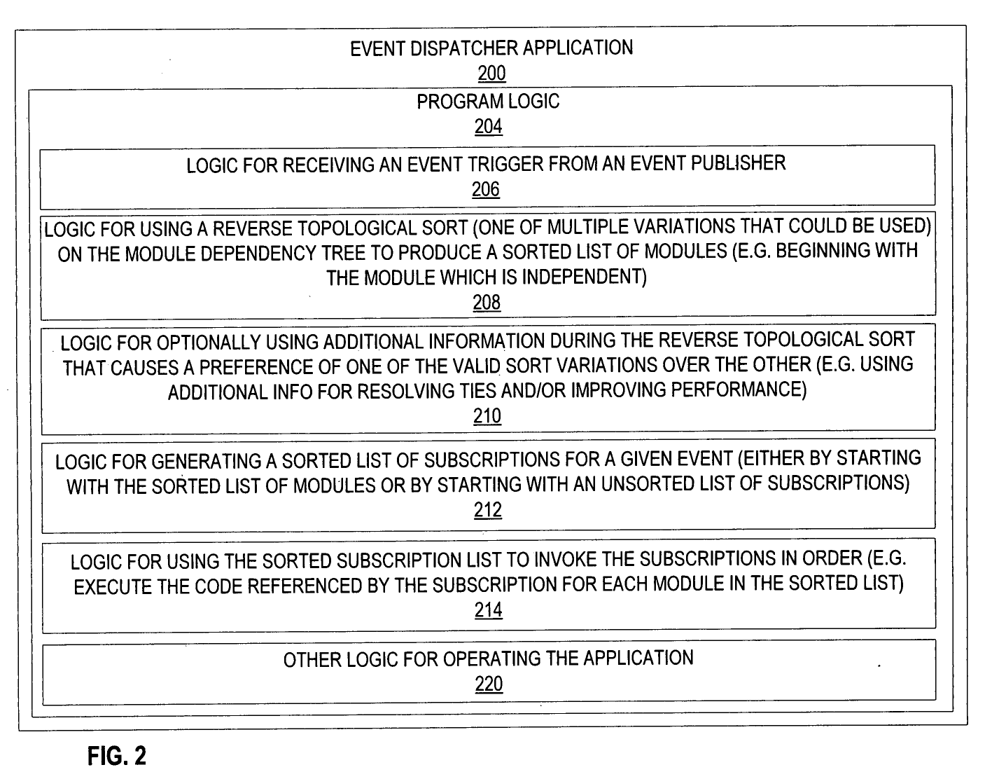

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes event dispatcher application 200 that communicates with one or more event publishers 113. Event dispatcher application 200 will be described in further detail in FIG. 2.

Turning now to FIG. 2 with continued reference to FIG. 1, an event dispatcher application 200 operating on computing device 100 is illustrated. Event dispatcher application 200 is one of the application programs that reside on computing device 100. However, it will be understood that event dispatcher application 200 can alternatively or additionally be embodied as computer-executable instructions on one or more computers and/or in different variations than shown on FIG. 1. For example, in one implementation, event dispatcher application 200 is embodied in one or more function libraries that are contained in one or more dynamic link libraries (DLL's). In another implementation, event dispatcher application 200 is embodied in one or more executable programs (EXE's). Alternatively or additionally, one or more parts of event dispatcher application 200 can be part of system memory 104, on other computers and/or applications 115, or other such variations as would occur to one in the computer software art.

Event dispatcher application 200 includes program logic 204, which is responsible for carrying out some or all of the techniques described herein. Program logic 204 includes logic for receiving an event trigger from an event publisher 206; logic for using a reverse topological sort (one of multiple variations that could be used) on the module dependency tree to produce a sorted list of modules (e.g. beginning with the module which is independent) 208; logic for optionally using additional information during the reverse topological sort that causes a preference of one of the valid sort variations over the other (e.g. using additional info for resolving ties and/or improving performance, etc.) 210; logic for generating a sorted list of subscriptions for a given event (either by starting with the sorted list of modules or by starting with an unsorted list of subscriptions) 212; using the sorted subscription list to invoke the subscriptions in order (e.g. execute the code referenced by the subscription for each module in the sorted list) 214; and other logic for operating the application 220. In one implementation, program logic 204 is operable to be called programmatically from another program, such as using a single call to a procedure in program logic 204.

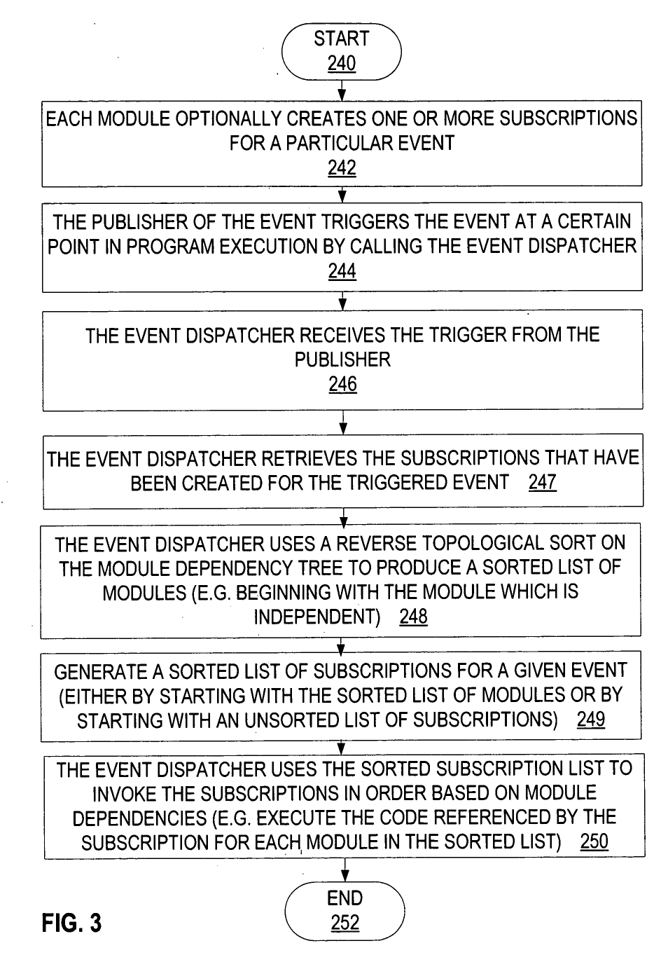

Turning now to FIGS. 3-9 with continued reference to FIGS. 1-2, the stages for implementing one or more implementations of event dispatcher application 200 are described in further detail. FIG. 3 is a high level process flow diagram for event dispatcher application 200. In one form, the process of FIG. 3 is at least partially implemented in the operating logic of computing device 100. The procedure begins at start point 240 with each module optionally creating one or more subscriptions for a particular event (stage 242). The publisher of the event triggers the event at a certain point in program execution by calling the event dispatcher (stage 244). The event dispatcher receives the trigger from the publisher (stage 246). The event dispatcher retrieves the subscriptions that have been created for the triggered event (stage 247). The event dispatcher uses a reverse topological sort on the module dependency tree to produce a sorted list of modules (e.g. beginning with the module which is independent) (stage 248). The event dispatcher generates a sorted list of subscriptions for a given event (either by starting with the sorted list of modules or by starting with an unsorted list of subscriptions, etc.) (stage 249). The event dispatcher uses the sorted subscription list to invoke the subscriptions in order (e.g. execute the code referenced by the subscription for each module in the sorted list) (stage 250). The process ends at end point 252.

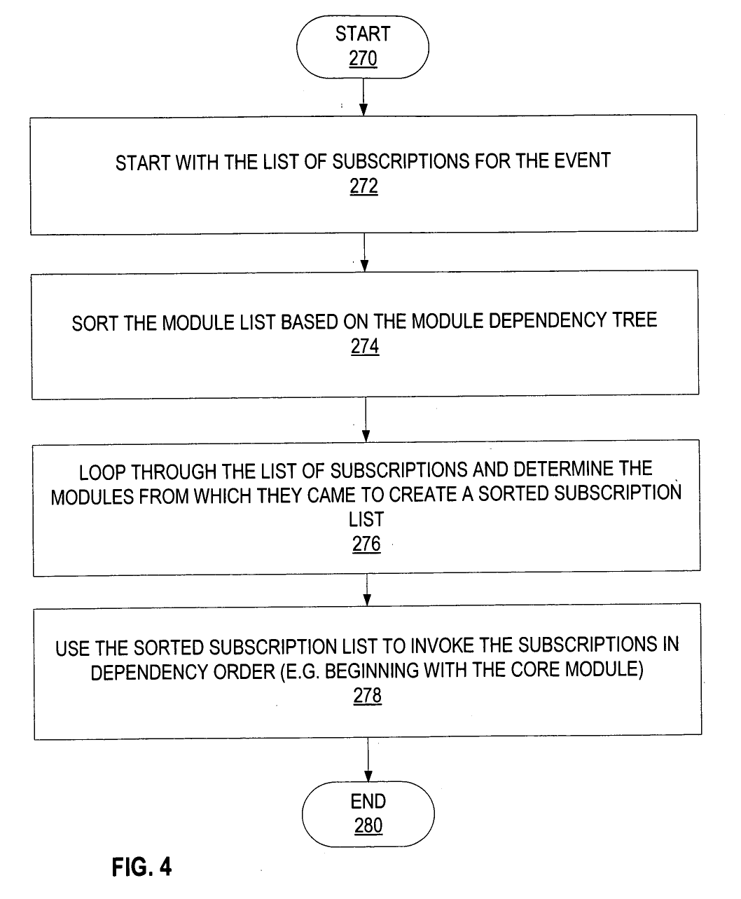

FIG. 4 illustrates one implementation of the stages involved in generating a sorted list of subscriptions for a given event from an unsorted list of subscriptions and a sorted module list by looking at a list of subscriptions first and then the modules from which they came. In one form, the process of FIG. 4 is at least partially implemented in the operating logic of computing device 100. The procedure begins at start point 270 with starting with the list of subscriptions for the event (stage 272). The system sorts the module list based on the module dependency tree (stage 274). The system loops through the list of subscriptions and determines the modules from which they came to create a sorted subscription list (stage 276). The event dispatcher uses the sorted subscription list to invoke the subscriptions in dependency order (e.g. beginning with the core module) (stage 278). The process ends at end point 280.

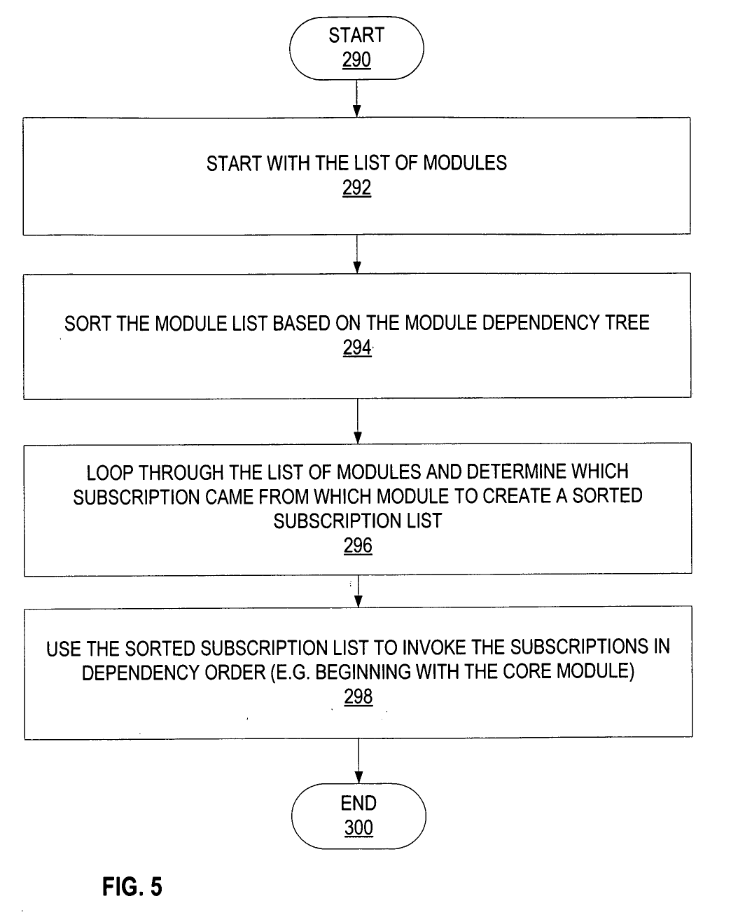

FIG. 5 illustrates one implementation of the stages involved in generating a sorted list of subscriptions for a given event from an unsorted list of subscriptions and a sorted module list by looking at the modules first and then the subscriptions. In one form, the process of FIG. 5 is at least partially implemented in the operating logic of computing device 100. The procedure begins at start point 290 with starting with the list of modules (stage 292). The module list is sorted based on the module dependency tree (stage 294). The system loops through the list of modules and determines which subscriptions came from which module to create a sorted subscription list (stage 296). The event dispatcher uses the sorted subscription list to invoke the subscriptions in dependency order (e.g. beginning with the core module) (stage 298). The process ends at end point 300.

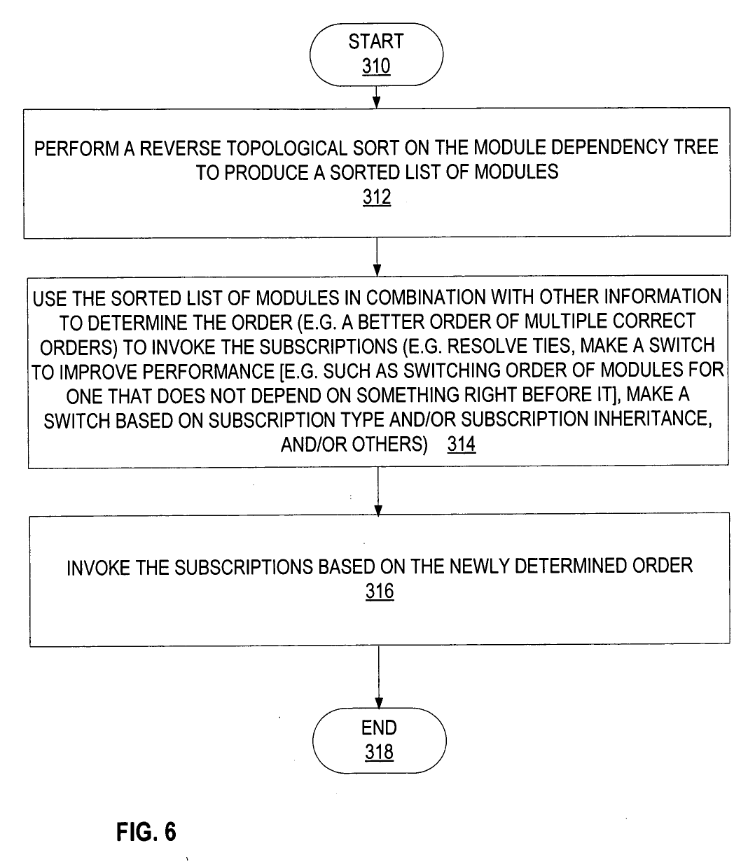

FIG. 6 illustrates one implementation of the stages involved in performing a reverse topological sort using dependency information plus additional information to determine the list. In one form, the process of FIG. 6 is at least partially implemented in the operating logic of computing device 100. The procedure begins at start point 310 with performing a reverse topological sort on the module dependency tree to produce a sorted list of modules (stage 312). The system uses the sorted list of modules in combination with other information to determine the final order (e.g. a better order of multiple correct orders) to invoke the subscriptions (e.g. to resolve ties, make a switch to improve performance [e.g. such as switching order of modules for one that does not depend on something right before it], and/or to make a switch based on subscription type, subscription inheritance, and/or others) (stage 314). The event dispatcher invokes the subscriptions based on the newly determined order (stage 316). The process ends at end point 318.

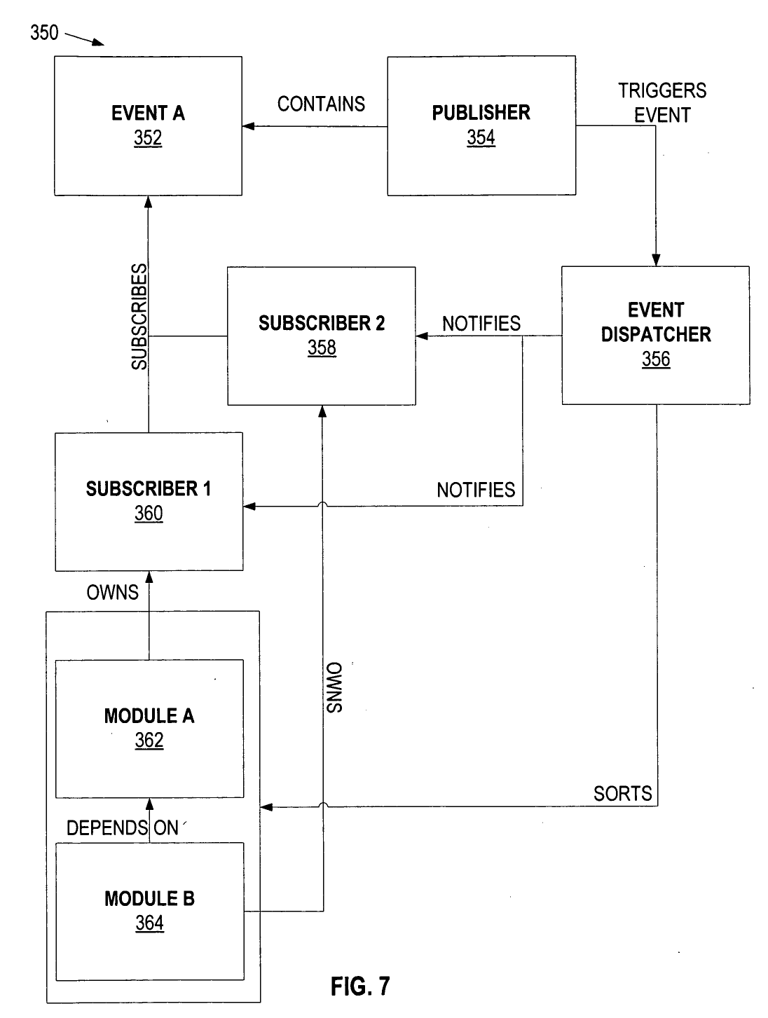

FIG. 7 is a logical diagram 350 for one implementation of the system of FIG. 1 that illustrates an interaction among hypothetical components. Event publisher (354) contains event A (352). Event publisher (354) triggers the event with event dispatcher (356) at a certain point in the program's execution. The event dispatcher (356) uses a reverse topological sort on the module dependency tree (module A [362] and module B [364]) to produce a sorted list of modules beginning with the module which is independent. Event dispatcher (356) then uses the sorted list to invoke the subscriptions in order of dependencies (e.g. notifies subscriber 1 [360] and then subscriber 2 [358]).

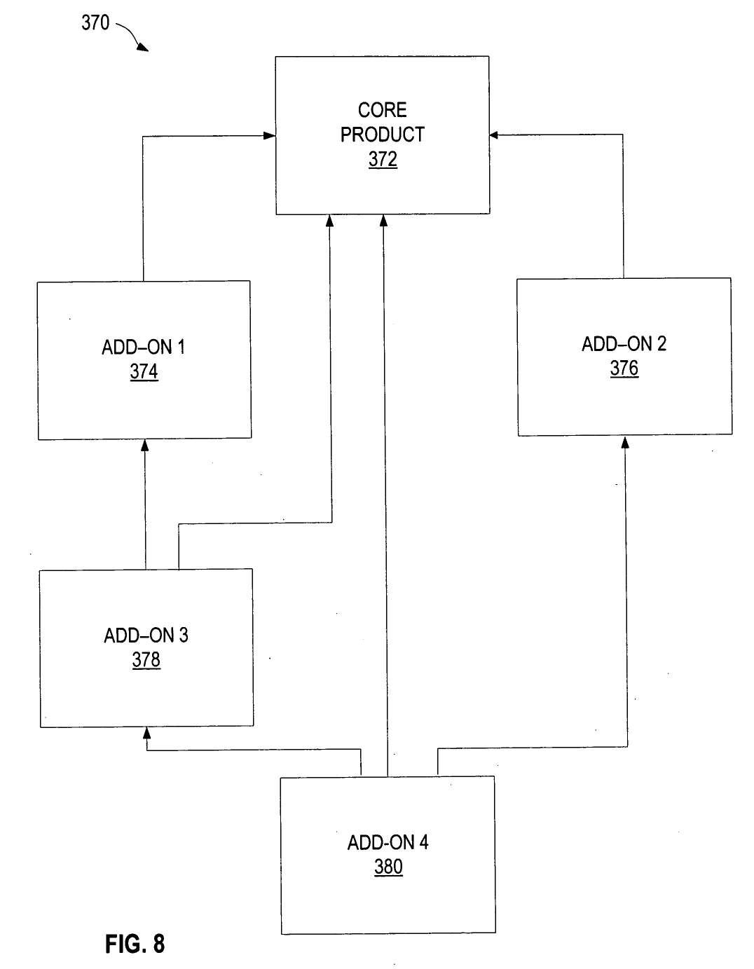

FIG. 8 is a logical diagram 370 for one implementation of the system of FIG. 1 that illustrates a sample module dependency tree. Diagram 370 illustrates a core product 372, with various add-ons that depend upon it directly or though another add-on (374, 376, 378, and 380, respectively). There are multiple valid reverse topological sorts for the modules shown in FIG. 8, as shown below:
Core, A01, A02, A03, A04
Core, A01, A03, A02, A04
Core, A02, A01, A03, A04
   In one implementation, any one of these reverse topological sort orders can be used for executing subscriptions in order by dependency, as they are each valid orders. In another implementation (as discussed in FIG. 6), additional information is used to help determine that one of these valid sort orders would be better than the other, such as one that would help resolve a tie or one that would help improve performance.

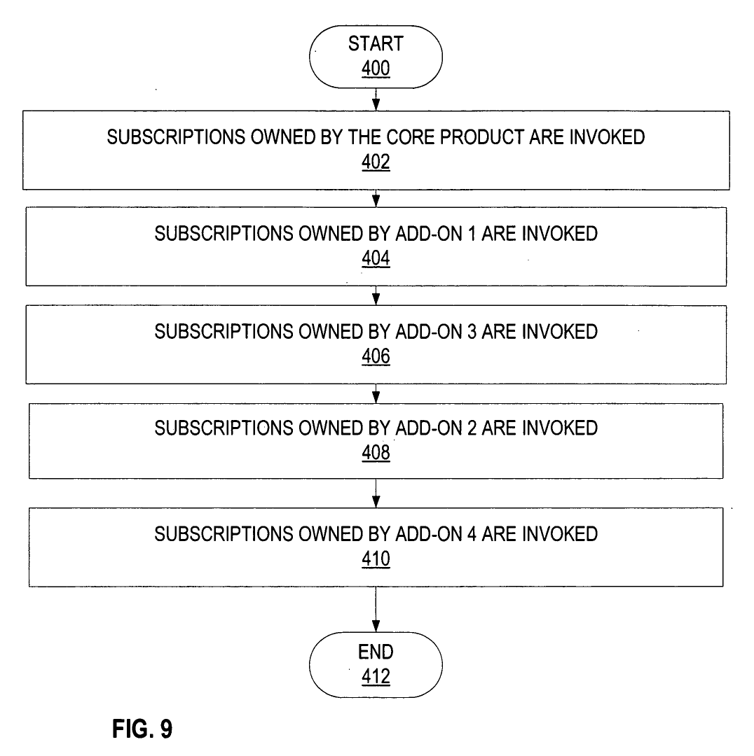

FIG. 9 illustrates one implementation of the stages involved in invoking the subscriptions for the dependency tree of FIG. 8 using event dispatcher application 200. In one form, the process of FIG. 9 is at least partially implemented in the operating logic of computing device 100. The procedure begins at start point 400 with subscriptions owned by the core product being invoked (stage 402). Subscriptions owned by add-on 1 are then invoked (stage 404). Subscriptions owned by add-on 3 are then invoked (stage 406). Next, subscriptions owned by add-on 2 are invoked (stage 408). Finally, subscriptions owned by add-on 4 are invoked (stage 410). The process ends at end point 412.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, and/or data layouts as described in the examples discussed herein could be organized differently on one or more computers to include fewer or additional options or features than as portrayed in the examples.

What is claimed is:

1. A method for dispatching events comprising the steps of:
receiving an event trigger for an event from an event publisher;
using a reverse topological sort on a module dependency tree to produce a sorted list of modules; and
using the sorted list of modules to invoke a plurality of subscriptions in a particular order based on one or more module dependencies.

2. The method of claim 1, wherein the sorted list has an independent module at the beginning of the sorted list.

3. The method of claim 1, wherein a sorted list of subscriptions is generated by looping through an unsorted list of subscriptions associated with the sorted list of modules to determine the modules from which the list of subscriptions came, and wherein the sorted list of subscriptions is used to determine the particular order for invoking the plurality of subscriptions.

4. The method of claim 1, wherein a sorted list of subscriptions is generated by looping through the sorted list of modules to determine which particular subscription came from which particular module, and wherein the sorted list of subscriptions is used to determine the particular order for invoking the plurality of subscriptions.

5. The method of claim 1, wherein each of the plurality of subscriptions are invoked by executing a corresponding code segment.

6. The method of claim 1, wherein the sorted list is used in combination with additional information to determine the particular order to invoke the plurality of subscriptions.

7. The method of claim 6, wherein the additional information includes a rule for handling ties.

8. The method of claim 6, wherein the additional information includes a rule for improving an application performance.

9. The method of claim 8, wherein the application performance is improved by switching an order of a particular module in the sorted list of modules.

10. The method of claim 9, wherein the particular module does not depend on a previous module located right before the particular module.

11. A computer-readable medium having computer-executable instructions for causing a computer to perform the steps recited in claim 1.

12. A computer-readable medium having computer-executable instructions for causing a computer to perform steps comprising:
receive an event trigger for an event from an event publisher;
use a reverse topological sort on a module dependency tree to produce a sorted list of modules, the sorted list of modules having each module in order by dependency; and
use the sorted list of modules to invoke a plurality of subscriptions in a particular order by dependency.

13. The computer-readable medium of claim 12, further having computer-executable instructions for causing a computer to perform the step comprising:
produce the sorted list of modules with an independent module at the beginning of the sorted list.

14. The computer-readable medium of claim 12, further having computer-executable instructions for causing a computer to perform steps comprising:
generate a sorted list of subscriptions by looping through an unsorted list of subscriptions associated with the sorted list of modules to determine the modules from which the list of subscriptions came; and
use the sorted list of subscriptions to determine the particular order for invoking the plurality of subscriptions.

15. The computer-readable medium of claim 12, further having computer-executable instructions for causing a computer to perform steps comprising:
generate a sorted list of subscriptions by looping through the sorted list of modules to determine which particular subscription came from which particular module; and
use the sorted list of subscriptions to determine the particular order for invoking the plurality of subscriptions.

16. The computer-readable medium of claim 12, further having computer-executable instructions for causing a computer to perform steps comprising:
use the sorted list in combination with additional information to determine the particular order to invoke the plurality of subscriptions.

17. The computer-readable medium of claim 12, further having computer-executable instructions for causing a computer to perform steps comprising:
improve an application performance by switching an order of a particular module in the sorted list of modules.

18. A method for dispatching events comprising the steps of:
receiving an event trigger for an event from an event publisher;
using a reverse topological sort on a module dependency tree to produce a sorted list of modules, the sorted list of modules having each module in order by dependency; and
using the sorted list of modules along with additional information to invoke a plurality of subscriptions in a particular order.

19. The method of claim 18, wherein the additional information is used to switch an order of a particular module in the sorted list of modules, the particular module not being dependent on a previous module located right before the particular module.

20. A computer-readable medium having computer-executable instructions for causing a computer to perform the steps recited in claim 18.
